(19) United States
(12) Patent Application Publication
(10) Pub. No.: US 2005/0205310 A1
(43) Pub. Date: Sep. 22, 2005

(54) Method and system for interactive and mobile advertising

(76) Inventor: Kent F. Pelz, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/065,782

(22) Filed: Feb. 24, 2005

Related U.S. Application Data
(60) Provisional application No. 60/548,219, filed on Feb. 26, 2004.

(51) Int. Cl. B62D 6/00; G09F 15/00

(52) U.S. Cl. 180/6.2; 40/606.02

(57) ABSTRACT

A method and system to draw the attention of, and interactively communicate a message to, a targeted group of people are described. According to one aspect of the invention, a self-balancing, mobile advertising vehicle includes a support platform for supporting an operator in a standing position, a steering mechanism to turn the self-balancing vehicle, and a motorized drive arrangement to propel the vehicle in response to the operator's leaning and shifting of weight. In addition, a superstructure including a structural frame and an outer shell are attached to, and extend upward from, the support platform. The outer shell may be partially or wholly shaped to surround the operator and conceal portions of the mobile vehicle. In addition, the outer shell may have one or more advertising messages affixed thereon.

### RELATED APPLICATIONS

The present application is related to, and claims priority from U.S. Provisional Application Ser. No. 60/548,219 filed on Feb. 26, 2004, which is hereby incorporated herein by reference

### FIELD OF THE INVENTION

The present invention relates generally to interactive and mobile advertising, and more particularly, the present invention relates to a method and system for drawing the attention of, and interactively communicating a persuasive message to, a targeted group of people with a human-operated, mobile advertising vehicle.

### BACKGROUND

It has long been customary for businesses and merchants to advertise their goods and services in an effort to generate sales. Historically, forms of advertising based on mass communication have been popular due to the large number of people that can be reached per advertising dollar. However, in more recent times, technological advances have decreased the costs associated with communicating with customers and businesses have been encouraged to move from mass communication to a more targeted and one-to-one dialogue with consumers. Several research studies have found that forms of advertising based on direct, one-to-one communication with consumers result in a significantly better return on investment than mass communication based advertising.

One-to-one, interpersonal communication with the consumer provides several advantages over mass media communications. First, and perhaps most obvious, the likelihood that a personally delivered persuasive message will be altogether ignored is less in a one-to-one two-way conversation than it is in a one-way mass communication message, such as a television or radio commercial. In addition, when the consumer is directly engaged, the consumer is more likely to make a connection with the provider of the message and therefore remember the content of the message. Furthermore, during one-to-one or one-to-few communication, the message can be tailored to the individual or group that is receiving the message.

To that end, businesses have come up with several new methods of communicating their messages to consumers. One such method is displaying a billboard-like display on a flat-bed truck or trailer. The display can be static, such as a traditional billboard, or alternatively the display may be capable of displaying video or computer graphic images. The display can be transported to select locations where crowds of people gather. However, despite the mobility of the display, the flat-bed billboard is still generally limited to streets and parking areas. In most cases, flat-bed displays are prohibited from entering public areas where large groups of people gather. Consequently, often times the display is only observable from a distance. Furthermore, a flat-bed mobile display lacks the one-to-one interaction that makes a personally communicated message so effective.

Another method of advertising involves riding a low-rider bicycle, such as a recumbent bicycle, customized with a billboard-like display in an area where people gather. This method is advantageous over the flat-bed display because the bicycle can operate in places where the vehicle is prohibited. However, this method of advertising has its own set of problems. In many locations, regulations exist that prohibit the use of bicycles on sidewalks and other paths dedicated to pedestrian traffic. Furthermore, bicycles are extremely difficult to maneuver in large crowded areas. Operating a bicycle takes a level of concentration that makes it rather difficult to engage in conversation and directly interact with other people. Furthermore, rather than attract positive attention that draws people in, bicycles often serve as obstacles in a crowded area that people perceive as an annoyance.

Another method of advertising—sometimes referred to as “feet on the street”—simply involves walking about a crowded area holding a sign. While this method solves some of the problems encountered with bicycle advertising, this method has other problems. A person's range of mobility with this method is limited to the endurance of the person carrying the sign. Walking about all day holding up a heavy sign can take a toll on a person's level of energy. This may negatively affect the person's enthusiasm, which, in turn, may be reflected in the delivery of the message. In addition, people walking about with signs may not be visible from a distance and may not pique the interest of passersby. In fact, a person holding a sign in a busy area may even be mistaken as a disgruntled employee on strike. Furthermore, unlike a dynamic video or graphic image, a static sign is limited in scope to the content of its message.

To improve the effectiveness of the “feet on the street” method of advertising, the Pixman Corporation of Montreal, Quebec, Canada, has designed a wearable, mobile, digital-display device. The Pixman® is a wearable mobile digital medium that can deliver a dynamic message by using characters, equipped with video screens or small, ultra-light digital projectors. A person wearing the mobile digital display device entertains and informs passersby in public places. The Pixman® concept is advantageous over the traditional “feet on the street” method of advertising in part due to the dynamic capabilities provided by the visual display. However, a wearable, mobile, digital-display device is limited to a size that a person can reasonably support. For example, there is a tradeoff between the size of the display and the overall level of mobility—the larger and heavier the display, the less mobile the person becomes. In addition, the person wearing the mobile display-device is not elevated in a crowd and therefore may not stand out and attract the level of attention that an elevated person would. Finally, the Pixman® does not allow the advertiser to make an instant impression upon a passerby. Instead, the advertiser's message is only effectively conveyed if a passerby stops and spends several minutes watching the video advertisement.

### SUMMARY OF THE DESCRIPTION

A method and system for drawing the attention of, and interactively communicating with, a targeted group of people are provided. According to one aspect of the invention, a person operates a self-balancing human transporter in a public location at which there is likely to be a crowd of people. The person operating the self-balancing human transporter may be dressed in a costume. Alternatively, the transporter may be configured with an outershell that conceals the human operator and the steering mechanism of the self-balancing human transporter device creating an illusion that the tranporter is effortlessly floating above the ground, thereby drawing the attention of passersby. As people approach the person operating the human transporter, the operator interacts with the people, in part, by communicating a message designed to influence and/or persuade.

According to another aspect of the present invention, the self-balancing human transporter is equipped with one or more visual displays. The visual displays are mounted on the human transporter in a manner that makes them readily visible to people interacting with the operator as well as people passing at some distance from the operator. The visual displays may be static, similar to a traditional billboard sign, or alternatively, the visual displays may be connected to a video or graphics source capable of projecting dynamic images, such as video and computer graphics, on the displays.

According to another aspect of the invention, the self-balancing human transporter is equipped with a computer and one or more input and output devices. One such output device attached to the human transporter and connected to the computer is an amplified loudspeaker system to play or broadcast pre-recorded music and/or audio messages, as well as the operator's spoken message. Other output devices that may be attached to the human transporter and connected to the computer include: a monitor, a compact printing device, and/or a marketing materials dispenser. The marketing materials dispenser, which may exist independently of the computer, may include a coupon dispenser to dispense pre-printed and perforated coupons.

In addition, the computer may be connected to one or more input devices, such as a keyboard, attached in a manner that allows persons with whom the operator is interacting to input information to the computer, such as an address, telephone number or email address. The computer may also be connected to the visual displays and serve as the source of video and graphic images for the visual displays.

According to another aspect of the invention, the self-balancing human transporter is equipped with a global positioning system (GPS) unit. The GPS unit is connected to the computer and can be used to determine and record the location of the human transporter over a period of time. The computer can analyze the recorded location data and output a report detailing the historical location of the human transporter for a specified time period.

Other aspects of the invention will be described below with respect to the drawings.

### BRIEF DESCRIPTION OF THE DRAWINGS

The present invention is illustrated by way of example and not limitation in the figures of the accompanying drawings, in which like references indicate similar elements and in which:

FIG. 1 illustrates an example of a self-balancing, human-operated, mobile advertising vehicle, including a structural frame for supporting an outer shell and/or visual display, consistent with one embodiment of the present invention;

FIG. 2 illustrates an example of a self-balancing, human-operated, mobile advertising vehicle including an outer shell to which one or more advertisements may be affixed, in accordance with an embodiment of the invention;

FIG. 3 illustrates an example of a self-balancing, human-operated, mobile advertising vehicle including various interactive and multi-media components that may be utilized in one or more embodiments of the invention;

FIGS. 4A, 4B, 4C and 4D illustrate examples of different configurations corresponding to various embodiments of a self-balancing, human-operated, mobile advertising vehicle; and,

FIG. 5 illustrates an example of a self-balancing, human-operated, mobile advertising vehicle in operation at a public area, consistent with one embodiment of the present invention.

### DETAILED DESCRIPTION

A method and system to draw the attention of, and interactively communicate a message to, a targeted group of people are described. In the following description, for purposes of explanation, numerous specific details are set forth in order to provide a thorough understanding of the present invention. It will be evident, however, to one skilled in the art that the present invention may be practiced without these specific details.

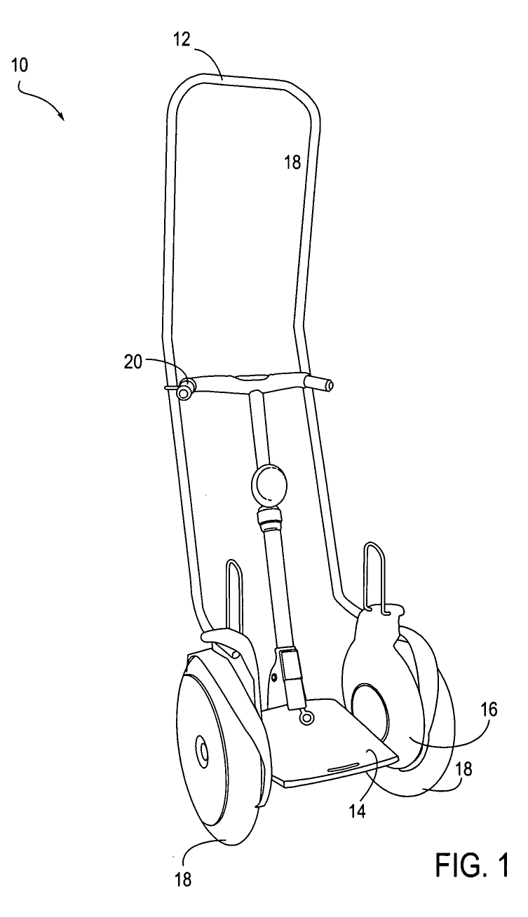

FIG. 1 illustrates an example of a self-balancing, human-operated, mobile advertising vehicle 10, including a structural frame 12 for supporting an outer shell and/or visual display, consistent with one embodiment of the present invention. The mobile advertising vehicle 10 may include a support platform 14 for supporting a human operator, generally, in a standing position. In addition, the mobile advertising vehicle may include a ground-contacting module capable of balanced operation over even and/or uneven surfaces on two laterally disposed and separately rotatable primary ground-contacting members 18. For example, in one embodiment of the invention, two independently motor-driven wheels 18 are positioned on opposite sides of the support platform 14. A motorized drive arrangement (not shown) may be mounted to the support platform 14 to drive the wheels and propel the vehicle 10 in response to the operator's leaning and shifting of weight. The motorized drive arrangement may be connected to a computing device and a group of sensors, including one or more gyroscopes, which function to operate the motor in a manner to keep the vehicle 10 balanced such that leaning of the vehicle 10 is not cancelled while it is in motion.

In addition, in one embodiment of the invention, the mobile advertising vehicle 10 may include a differential controller (not shown) that causes each of the two wheels 18 to be differentially driven, thereby causing a specified turning motion of the vehicle 10. The differential controller may be activated in response to the operator manipulating a steering mechanism 20 on the vehicle 10.

In one embodiment of the invention, such as that illustrated in FIG. 1, the mobile advertising vehicle 10 may essentially consist of a superstructure attached to a Segway® HT, manufactured and distributed by Segway, LLC of Manchester, N.H. The Segway® HT is part of a new class of transportation devices often referred to as Electric Personal Assistive Mobility Devices, or alternatively, Personal Motorized Mobility Devices. The Segway® HT has solid state gyroscopes, tilt sensors, high speed microprocessors, and powerful electric motors performing to keep it balanced and upright. The Segway® HT balances in much the same way that its operator does, moving forward and backward, responding to the operator's change in position and shifting of weight. The result is that the operator of the Segway® HT appears as if he is effortlessly floating over the ground. This fluid motion has the effect of drawing the attention of passersby, making the Segway® HT an excellent platform for a mobile advertising vehicle.

In one embodiment, the structural frame 12 of the superstructure, which may be configured to attach to the ground contacting member and/or support platform of the vehicle, may be comprised of lightweight aluminum tubing. In alternative embodiments, the structural frame may be configured or shaped in a wide variety of ways. However, generally, the structural frame may extend upwardly from the support platform of the vehicle. In one embodiment, the structural frame 12 may support one or more visual displays attached atop the vehicle. In addition, the structural frame may provide mounting points to support an outer shell that may be configured to partially or wholly wrap around the operator without obstructing the operator's operational view. The outer shell may have one or more advertising images or messages affixed thereon. In addition, the outer shell may be configured to take on the shape of an object associated with a particular advertising message.

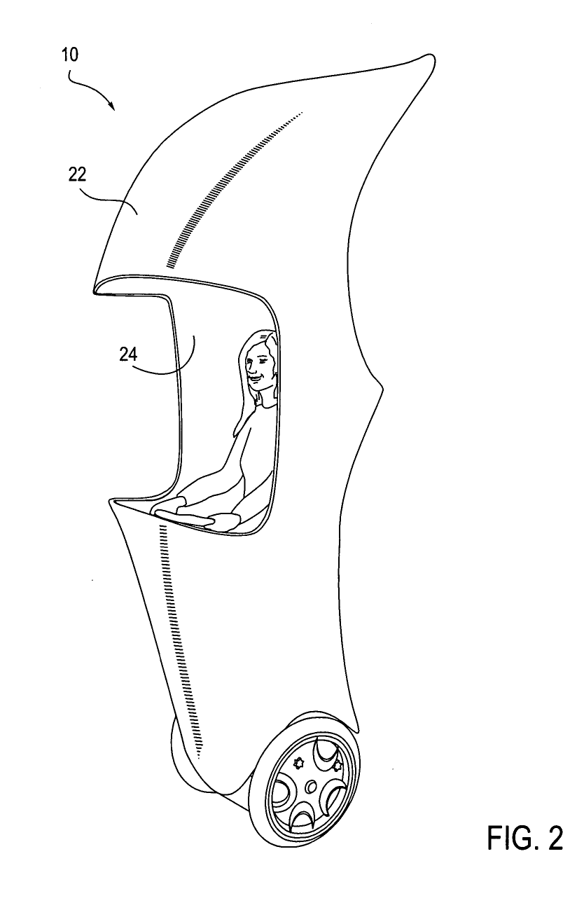

FIG. 2 illustrates an example of a self-balancing, human-operated, mobile advertising vehicle 10 including an outer shell 22 to which one or more advertisements may be affixed, in accordance with one embodiment of the invention. In one embodiment of the invention, a human operator 24 of the mobile advertising vehicle may be dressed in a costume that partially or wholly conceals the self-balancing, mobile advertising vehicle creating an illusion that the costumed person is effortlessly floating above the ground, thereby drawing the attention of passersby. In one embodiment, the costume may be a light weight outer shell 22 attached to the structural frame 12 of the superstructure and shaped to communicate a particular visual message. For example, the outer shell may be configured in a shape associated with a product being advertised. However, in an alternative embodiment, the operator may wear a costume that does not conceal the vehicle. In either case, as people approach the person 24 operating the vehicle, the operator 24 may interact with the people, in part by communicating a message designed to influence and/or persuade.

The mobile advertising vehicle might be deployed in any number of crowded or high pedestrian traffic areas, for example, amusement parks, beaches, carnivals, intersections and street fairs. The costume will typically be tailored to the message being communicated. For example, the operator might don a costume of a company mascot. In addition, the operator may distribute marketing materials including flyers, brochures, coupons and/or product samples. In one embodiment of the invention, the operator may even distribute or sell a limited amount of product.

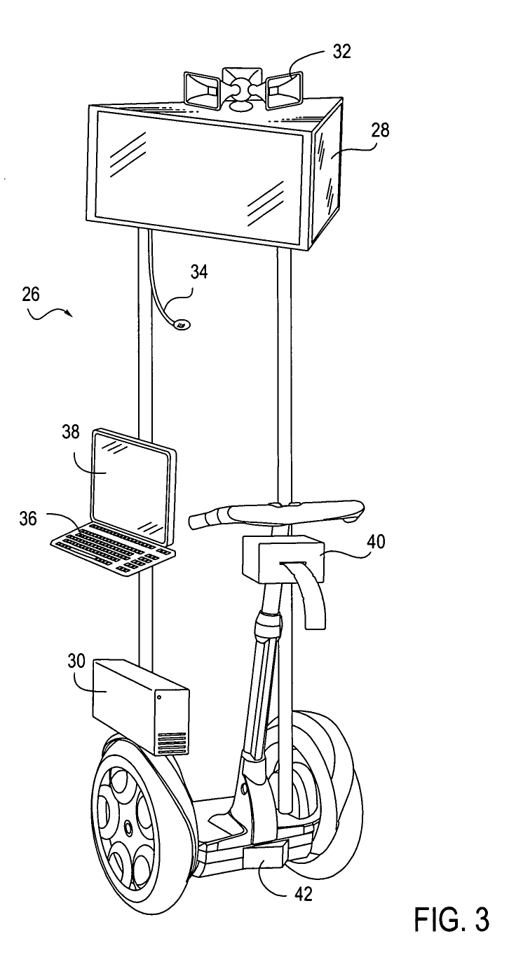

FIG. 3 illustrates an example of a self-balancing, human-operated, mobile advertising vehicle 26 including various interactive and multi-media components that may be utilized in one or more embodiments of the invention. For example, in one embodiment of the invention, the mobile advertising vehicle 26 may be equipped with one or more visual displays 28. The visual displays 28 may be mounted on the human transporter in any manner that makes them readily visible to people interacting with the operator as well as people passing by at some distance from the operator. In FIG. 3, the vehicle is shown with three visual displays 18 mounted high above where the operator's head would be, in a triangular arrangement. However, in alternative embodiments, any number of visual displays may be used and mounted in a variety of positions. In particular, it may be preferred to configure and position the visual displays to be visible from various locations relative to the vehicle. For example, in one embodiment two visual displays may be mounted back to back, or four visual displays may be mounted in a square configuration. In addition, one or more visual displays may be mounted on a rotating mounting platform so that the visual displays may rotate atop the vehicle.

The visual displays may be static, similar to traditional billboard signs. Preferably, however, the visual displays are connected to a video or graphics source capable of projecting dynamic images on the displays. For example, the visual displays may be lightweight, liquid crystal displays (LCDs) or digital image projectors. In addition, the displays may be specifically designed and configured to display bright images in outdoor environments.

The mobile advertising vehicle 26 may be equipped with a computing device 30 and one or more input and/or output devices. For example, in one embodiment of the invention, the computing device 30 may be mounted to the vehicle above one of its two wheels. Alternatively, the computing device may be mounted in the rear of the vehicle on the support platform, or hidden within the enclosure created by the three visual displays. The computing device may serve as the source of video and graphic images for the visual displays 28.

One output device that may be attached to the vehicle 28 and connected to the computer 30 is an amplified loudspeaker system 32 to play or broadcast pre-recorded music and/or audio messages. In addition, the operator may use a microphone 34, connected to the loudspeaker 32 and computer 30, to entertain and/or broadcast announcements to groups of people within the vicinity of the vehicle.

In one embodiment of the invention, the computer 30 may be connected to one or more input devices, such as a keyboard 36, attached in a manner that allows persons with whom the operator is interacting to input information to the computing device 30, such as an address, telephone number or email address. The computing device 30 may have larger than usual keys, making it easier for someone to use while the operator is balancing the vehicle in a stationary position. Additionally, a small monitor 38 may be mounted to the transporter 26 allowing the person inputting information to view the information, as it is being input. Consequently, the operator of the mobile advertising vehicle may collect information from people to be used to contact them at a later time.

Another output device that may be attached to the human transporter is a compact printing device, and/or a marketing materials dispenser 40. For example, a compact printing device 40 may be used to print coupons or other marketing materials. Alternatively, a coupon dispenser may be attached to the vehicle. For example, the coupon dispenser might store and dispense one or more rolls of pre-printed and perforated coupons. In one embodiment of the invention, each coupon may have a source code printed thereon. In this manner, the source of the coupon, if redeemed, can be tracked and the overall effectiveness of the advertising measured.

According to another aspect of the invention, the self-balancing human transporter may be equipped with a global positioning system (GPS) unit 42. In one embodiment of the invention, the GPS unit 42 may be connected to the computing device 30 and may be used to determine and record the location of the vehicle over a period of time. The computing device 30 may analyze the recorded location data and output a report detailing the historical location of the mobile advertising vehicle for a specified time period. Accordingly, at the end of an advertising contract or period, an advertising provider may use the report to provide a client with verifiable evidence that the mobile advertising vehicle covered the particular geographical location, or venue, promised.

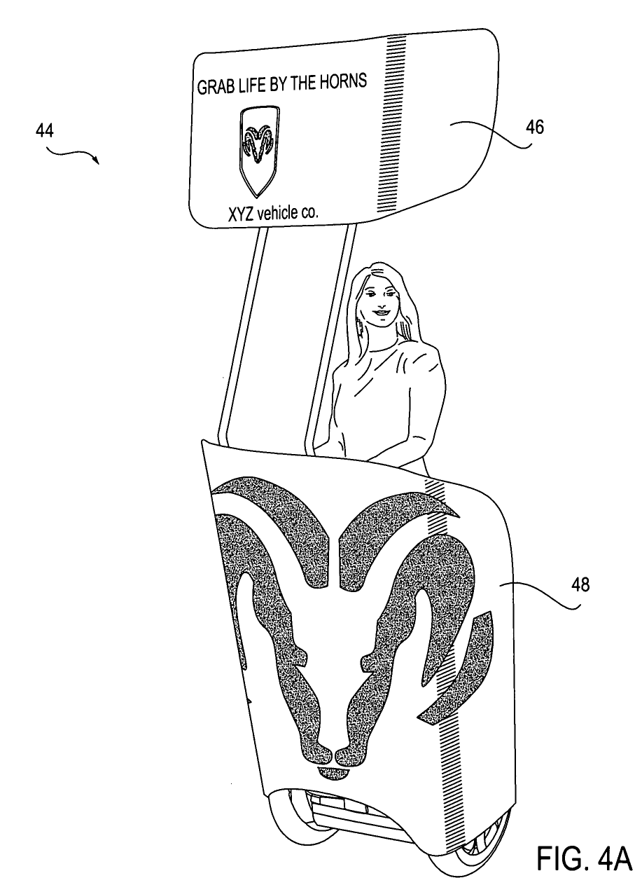

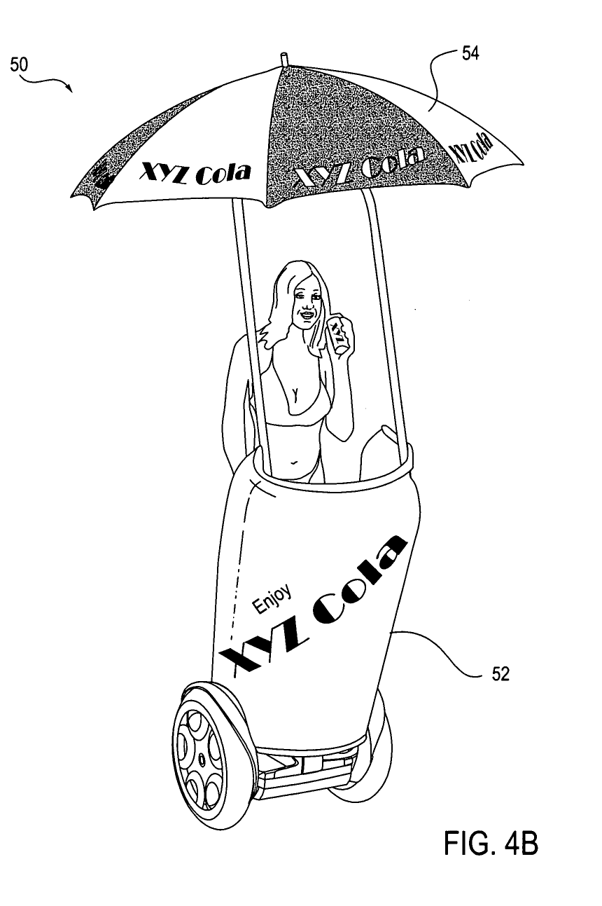

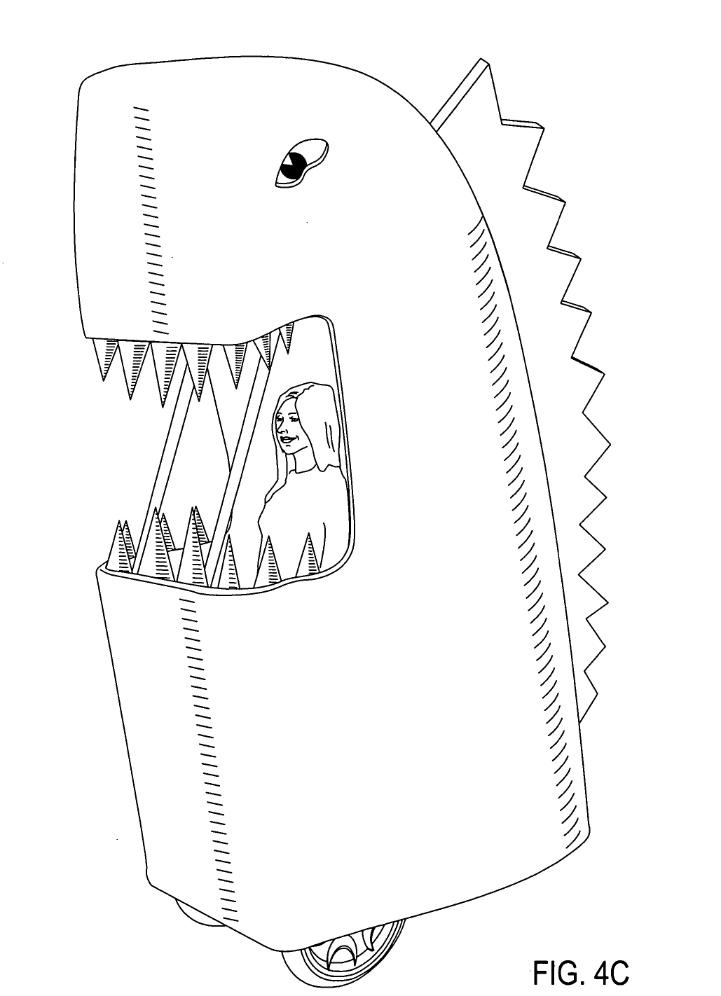

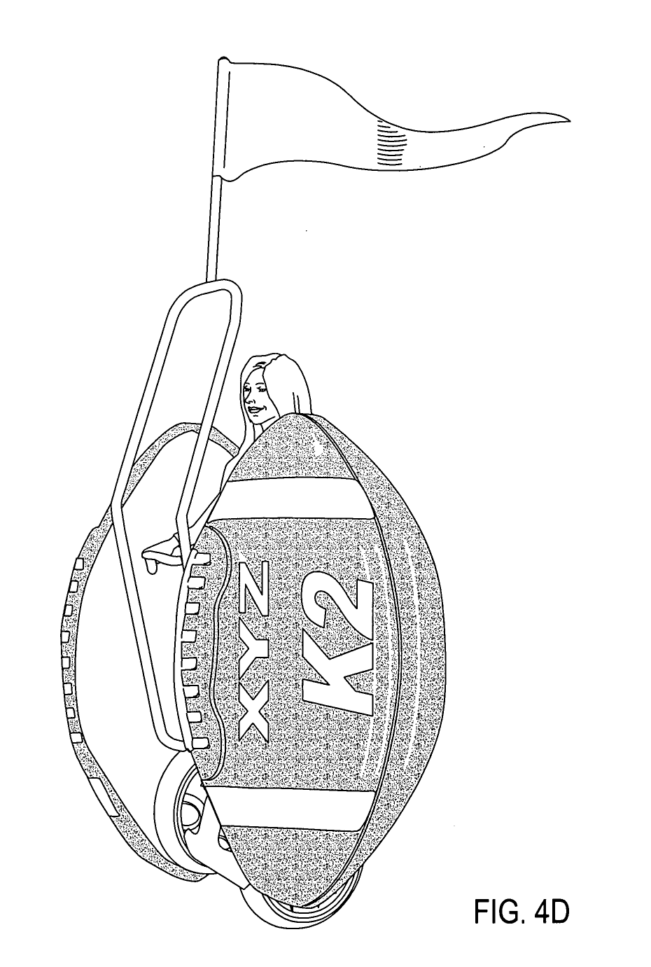

FIGS. 4A, 4B, 4C and 4D illustrate examples of different configurations corresponding to various embodiments of a self-balancing, human-operated, mobile advertising vehicle. In FIG. 4A, the mobile advertising vehicle 44 is shown with an outer shell consisting of two distinct components, an upper outer shell 46, and a lower outer shell 48. Accordingly, advertising messages may be affixed to one or both components of the outer shell 46 and 48. One particularly advantageous aspect of the embodiment of the invention illustrated in FIG. 4A is that the upper outer shell 46 may be seen from a fairly significant distance when the mobile advertising vehicle is operated in a crowd of people.

In FIG. 4B, the mobile advertising vehicle is shown with an outer shell 52 that is configured as a large soda can. In addition, an umbrella-like structure 54 is shown attached to the structural frame above the operator's head. The umbrella-like structure serves a dual purpose. It may provide shelter to the operator of the vehicle from the sun and rain, as well as communicate a visual advertising message. The mobile advertising vehicle 50 illustrated in FIG. 4B may be used to distribute sample products. Accordingly, a storage container (not shown) may be attached to the vehicle.

FIGS. 4C and 4D illustrate embodiments of the invention with outer shells configured in the shape of objects meant to communicate a particular message. For example, FIG. 4C illustrates an embodiment of the invention with an outer shell configured as a mascot of a sporting team. Finally, the mobile vehicle illustrated in FIG. 4D has an outer shell configured in the shape of a football.

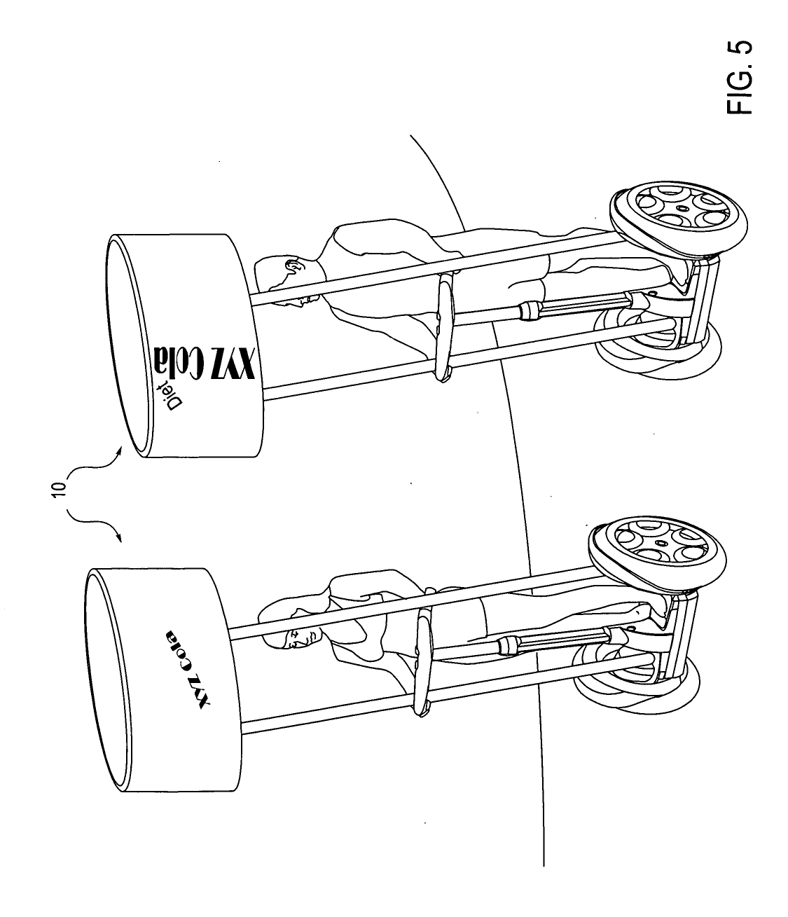

FIG. 5 illustrates an example of a self-balancing, human-operated, mobile advertising vehicle in operation at a public area. Consistent with one embodiment of the present invention, a person may operate a self-balancing, mobile advertising vehicle in a public location at which there is likely to be a crowd of people. The fluid motion of the vehicle may draw the attention of passersby, particularly when the vehicle is configured with an outer shell shaped to partially or wholly conceal the operator and the steering mechanism of the vehicle.

The present invention is advantageous over previous methods of mobile advertising for several reasons. First, the fluid motion of the operator captures the curiosity of passersby drawing them towards the operator, particularly when the human transporter is concealed by the operator's costume. The personal-advertising human transporter can go places other mobile platforms, such as bicycles, cannot go. The transporter's unique ability to self-balance and its relatively small footprint—just slightly larger than a person—make it an ideal mobile advertising platform for interacting with groups of people in crowded public areas. In addition, the personal-advertising human transporter provides a platform for a significantly larger display than a pedestrian is capable of carrying. The human transporter is capable of carrying multimedia devices, including input devices that allow the operator to collect information in addition to communicating a message.

1. A mobile advertising device, comprising:
a support platform to support a human operator;
a ground contacting module capable of balanced operation on two laterally disposed and separately rotatable primary ground-contacting members, the support platform and the ground-contacting module being components of an assembly;
a motorized drive arrangement, mounted to the assembly, the motorized drive arrangement causing, when powered, motion of the assembly in such a manner as to propel the assembly in response to leaning of the device and such that leaning of the device is not cancelled while the device is in motion;
a differential controller actuatable to cause each of the two ground-contacting members to be differentially driven so as to cause a specified turning motion of the device about a device-fixed vertical axis, the differential controller being actuatable by the user via a steering mechanism; and
a superstructure attached to the assembly, the superstructure including a skeletal frame and a visual display for communicating an advertising message, the skeletal frame extending upwardly from the assembly and supporting the visual display in a position above the support platform.

2. The mobile advertising device of claim 1, wherein the visual display is configured so the advertising message is viewable by persons situated at multiple positions relative to the device.

3. The mobile advertising device of claim 1, wherein the visual display is capable of projecting dynamic images.

4. The mobile advertising device of claim 3, further comprising:
an image source connected to the visual display, said image source storing one or more images for display on the visual display.

5. The mobile advertising device of claim 1, further comprising:
an audio source; and
a loudspeaker to broadcast audio from the audio source.

6. The mobile advertising device of claim 5, wherein the audio source is a microphone.

7. The mobile advertising device of claim 5, further comprising:
a microphone connected to the loudspeaker, wherein the microphone is positioned so the operator can speak into the microphone while operating the device.

8. The mobile advertising device of claim 1, further comprising:
an outer shell supported by the skeletal frame of the superstructure, the outer shell (i) shaped to partially or wholly surround the human operator, when the human operator is in a standing position on the support platform, but not obstruct the human operator's operational view, and (ii) communicate an advertising message affixed thereon.

9. The mobile advertising device of claim 8, wherein the outer shell extends upwardly from the support platform to a position above the operator's head, and at least one advertising message is affixed to the outer shell in a position above the operator's head.

10. A mobile advertising device, comprising:
a support platform to support a human operator of the device;
a ground contacting module capable of balanced operation on two laterally disposed and separately rotatable primary ground-contacting members, the support platform and the ground-contacting module being components of an assembly;
a motorized drive arrangement, mounted to the assembly, the motorized drive arrangement causing, when powered, motion of the assembly in such a manner as to propel the device in response to leaning of the device and such that leaning of the device is not cancelled while the device is in motion;
a differential controller actuatable to cause each of the two ground-contacting members to be differentially driven so as to cause a specified turning motion of the device about a device-fixed vertical axis, the differential controller being actuatable by the user via a steering mechanism; and
a superstructure including a skeletal frame and an outer shell, the skeletal frame attached to the assembly so as to extend upwardly and support the outer shell, the outer shell shaped (i) to partially or wholly surround the human operator without obstructing the human operator's operational view, and (ii) to communicate a visual advertisement affixed to the outer shell in at least one location above the support platform.

11. The mobile advertising device of claim 10, wherein the outer shell is comprised of multiple members including a lower member and an upper member, the lower member shaped to conceal the support platform and the steering mechanism, the upper member positioned above the support platform.

12. The mobile advertising device of claim 10, further comprising:
a visual display supported by the skeletal frame of the superstructure and communicatively coupled to a computing device, the visual display to display video from a video file stored on the computing device; and
at least one loudspeaker supported by the skeletal frame of the superstructure and communicatively coupled to the computing device, the loudspeaker to broadcast audio from an audio file stored on the computing device or from a microphone.

13. The mobile advertising device of claim 12, further comprising:
a keyboard communicatively coupled to the computing device and supported by the superstructure so as to be operable by a person facing the human operator when the device is in a stationary state; and
a second visual display communicatively coupled to the computing device and supported by the superstructure so as to be viewable by the person facing the human operator as the person interacts with the keyboard.

14. The mobile advertising device of claim 12, further comprising:
a printing device communicatively coupled to the computing device, the printing device for printing materials to be dispensed to persons in the vicinity of the device.

15. The mobile advertising device of claim 10, further comprising:
a marketing materials dispenser supported by the superstructure, the marketing materials dispenser for dispensing pre-printed marketing materials to persons in the vicinity of the device.

16. The mobile advertising device of claim 10, further comprising:
a global positioning system for recording a geographical location in which the device is operated.

17. A method comprising:
causing a mobile advertising device to be operated by a human operator in a public place where the mobile advertising is likely to be observed by a number of passersby, the mobile advertising device comprising:
a support platform to support a human operator;
a ground contacting module capable of balanced operation on two laterally disposed and separately rotatable primary ground-contacting members, the support platform and the ground-contacting module being components of an assembly;
a motorized drive arrangement, mounted to the assembly, the motorized drive arrangement causing, when powered, motion of the assembly in such a manner as to propel the assembly in response to leaning of the device and such that leaning of the device is not cancelled while the device is in motion;
a differential controller actuatable to cause each of the two ground-contacting members to be differentially driven so as to cause a specified turning motion of the device about a device-fixed vertical axis, the differential controller being actuatable by the user via a steering mechanism; and
a superstructure attached to the assembly, the superstructure including a skeletal frame and a visual display for communicating an advertising message, the skeletal frame extending upwardly from the assembly and supporting the visual display in a position above the human operator.
